(19) United States
(12) Patent Application Publication
(10) Pub. No.: US 2008/0195666 A1
(43) Pub. Date: Aug. 14, 2008

(54) Automatic file saving method for digital home appliance system

(75) Inventor: Wei-Hsiang Chi, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 12/068,478

(22) Filed: Feb. 7, 2008

(30) Foreign Application Priority Data
Feb. 9, 2007 (TW) 096104749

(51) Int. Cl. G06F 7/00; G06F 17/00; G06F 17/30

(52) U.S. Cl. 707/104.1; 707/E17.044

(57) ABSTRACT

The invention provides an automatic file saving method for a digital home appliance system. A storage position for saving a multimedia file is automatically selected based on collected information related to the multimedia files. In addition, the file size in the digital home appliance system also may be recorded, and when a limited file size is reached, the backup operation may be executed automatically.

### BACKGROUND OF THE INVENTION

1. Field of the Invention

The invention relates to a technical field of the digital home appliance and, more particularly, to an automatic file saving method for a digital home appliance system.

2. Description of the Related Art

When the function and the universality of the home appliance are increased, the multimedia file may be obtained from various kinds of digital home appliance devices such as a digital camera, a computer, or a television with a card reader and be stored in a plurality of different storage media such as a hard disk of a personal computer, a network hard disk or a portable medium player. However, it is inconvenient to transfer the multimedia file in different digital home appliance devices and storage media. For example, since the television usually does not have an input device such as a mouse or a keyboard, so that executing the operation functions such as copying, searching files, editing images or inputting words is difficult.

In addition, since the kinds of the storage device increase, and different family member has different storage classifying custom, so that data or files may be individually stored in different storage devices. The Users have to spend more time to search the certain data or file in various storage devices. Sometimes, the same data or file may be stored repeatedly, the space of the storage device is wasted.

In addition, in the conventional method, the data or the file is classified and stored in a manual mode. It is difficult to classify the image files according to the photographing date, the name of the photographing device, specific person or a group of persons by the user. The files only can be search by the name of the file, the revise date, strings in the file, the size of the file. Therefore, how to provide an method to search the certain file quickly in a plurality of storage device has been a subject which needs to be solved.

### BRIEF SUMMARY OF THE INVENTION

The objective of the invention is to provide an automatic file saving method for a digital home appliance system. A digital home appliance system having practicability and convenience is disclosed.

According to the object of the invention, an automatic file saving method is provided. The automatic file saving method is applied to the digital home appliance system including a plurality of digital home appliance devices with at least a storage position. The automatic file saving method includes the following steps. A storage request for a file is received. The information of the file is collected to obtain the related storage parameters, and the file is stored to the storage position corresponding to the related storage parameters.

The above related storage parameters may include a building date, a file size, a source position, a file type and a characteristic graphic icon and any combination thereof.

To collect the information of the characteristic graphic icon in the embodiment of the invention, the steps include providing a plurality of linear cursors at the screen of the digital home appliance system and defining the boundary of the characteristic graphic icon by the position of each of the linear cursor to select the characteristic graphic icon.

According to another object of the invention, the embodiment of the invention further includes the steps of numbering the size of the file into an un-backup file size, comparing the un-backup file size and a backup default file size, and displaying a backup prompting message if the un-backup file size is larger than the backup default file size.

The embodiment of the invention includes a digital home appliance system to cooperate with the above method. The digital home appliance system includes a plurality of digital home appliance devices, a digital-home-appliance control device and a domestic network. Each of the digital home appliance devices has at least a storage position. The plurality of digital home appliance device and the control devices are linked with the domestic network to transmit data or control signals by the domestic network. When the control device receives a file massage, it collects the information about the file to obtain a related storage parameter and stores the file to a storage position corresponding to the related parameter.

These and other features, aspects, and advantages of the present invention will become better understood with regard to the following description, appended claims, and accompanying drawings.

### BRIEF DESCRIPTION OF THE IMAGE FILES

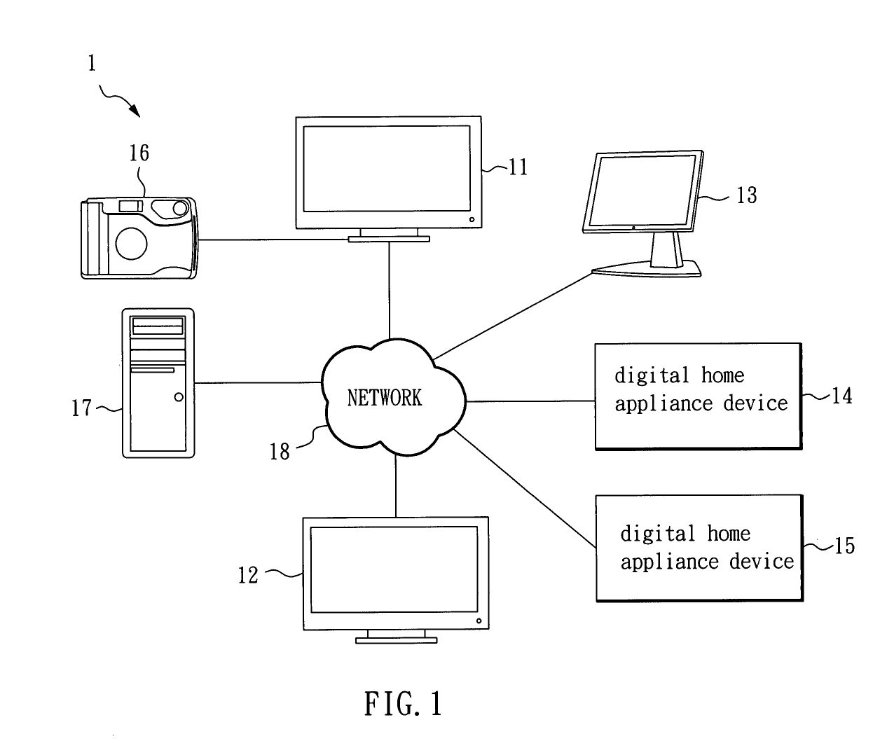

FIG. 1 is a schematic diagram showing the digital home appliance system according to a preferred embodiment of the invention.

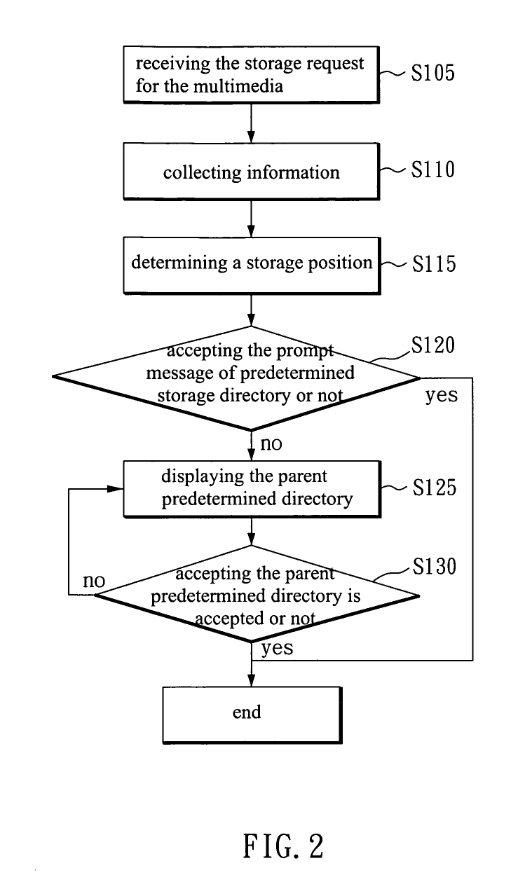

FIG. 2 is a flowchart of a first preferred embodiment of the invention.

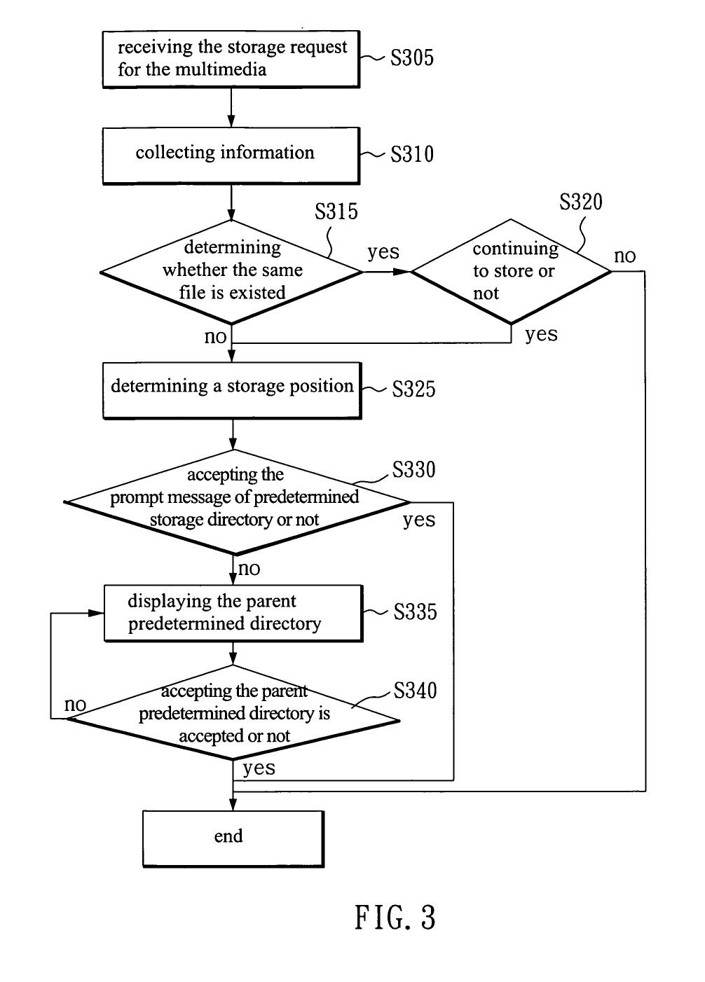

FIG. 3 is a flowchart of a second preferred embodiment of the invention.

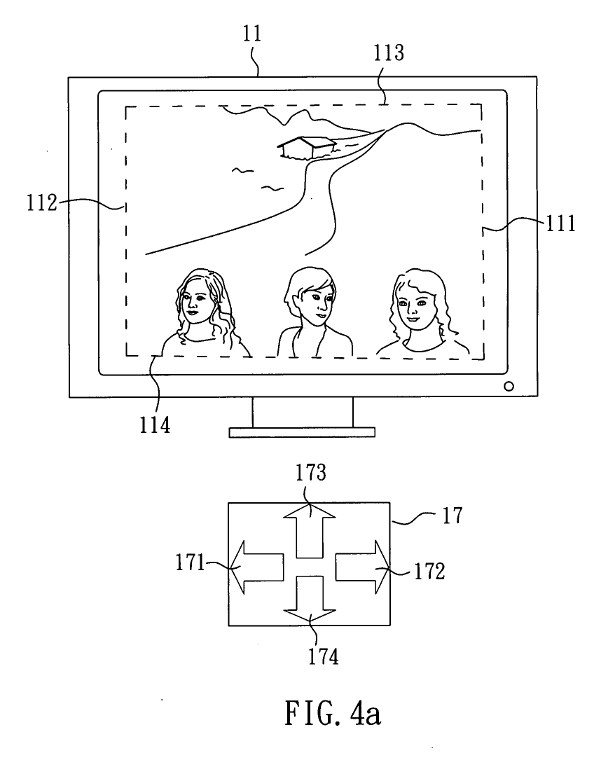

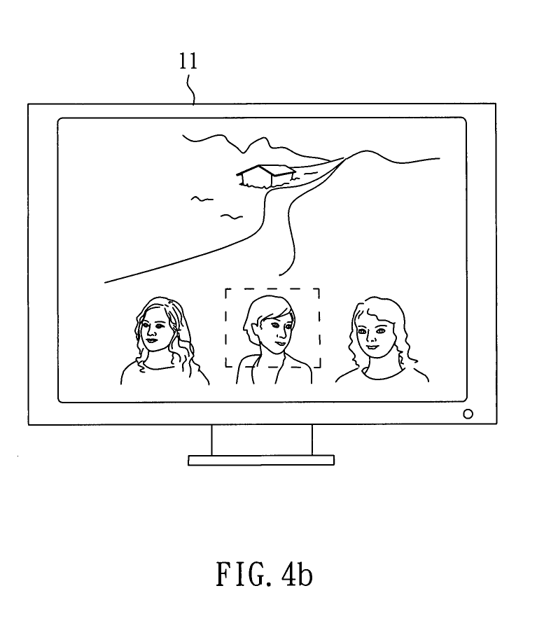

FIG. 4a and FIG. 4b are schematic diagrams of a third embodiment of the invention.

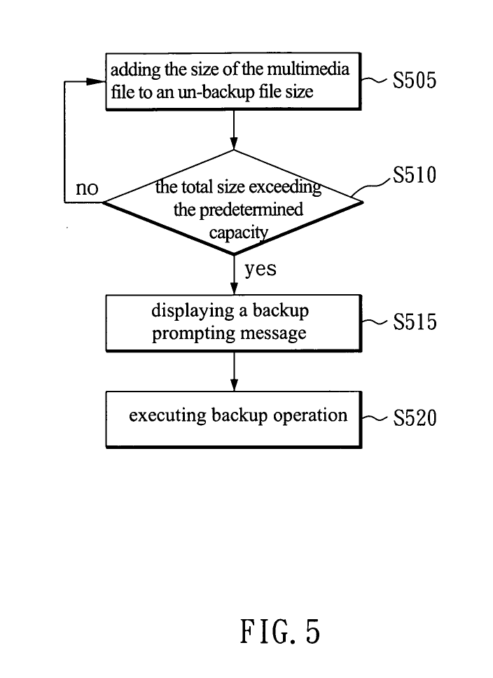

FIG. 5 is a flowchart showing the automatic backup according to the fourth embodiment of the invention.

### DETAILED DESCRIPTION OF THE EMBODIMENTS

FIG. 1 is a schematic diagram showing a digital home appliance system 1 according to a preferred embodiment of the invention. The digital home appliance system 1 includes digital televisions 11, 12, a computer 13, other digital home appliance devices 14, 15, a digital camera 16, a digital-home-appliance control device 17 and a domestic network.

The digital televisions 11 and 12, the computer 13, the digital home devices 14 and 15 and the digital-home-appliance control device 17 establishes a link with the domestic network 18 and transmits data or control signals to each other via the domestic network 18.

In the embodiment, the domestic network 18 may be the network such as IEEE 802.3 (high-speed Ethernet wireless network), IEEE 802.11 (wireless network), IEEE 802.15 (wireless personal area network), the Bluetooth network or the electric power wire network. In the embodiment, the digital home appliance device 14 may be a refrigerator, a video device, an air conditional or an oven and so on. In the embodiment, the digital home appliance device 15 may be a storage device a high capacity (such as a redundant array of independent disks (RAID) or a network-attached storage (NAS)). In the embodiment, the digital-home-appliance control device 17 may be a control host achieved by a personal computer, a server or other information technology.

FIG. 2 is a flowchart showing the automatic saving process provided by a first preferred embodiment of the invention. Please refer to FIG. 2 and FIG. 1. When a user wants to store the multimedia stored in the digital camera 16 (which also may be a portable device such as a mobile phone, a personal digital assistant (PDA) or a memory disk) in the digital home appliance system 1, the user should make the digital camera 16 electrically connected to one digital device (such as the digital television 11). So that the multimedia stored in the digital camera 16 and the storage request may be transferred to the digital home appliance system 1 by the digital device. First, the digital-home-appliance control device 17 receives the storage request for the multimedia (step S105).

The digital television 11 have a card reader for reading the multimedia in the digital camera 16. In addition, after the digital camera 16 is electrically connected to the digital television 11, the digital-home-appliance control device 17 collects the information to obtain a plurality of related storage parameters (step S110). The collected information may be file data, device data, content data or favorite setting of users. The collected related storage parameters may include any combination of the building data, file size, source position, file type and the characteristic graphic icon.

For example, the digital-home-appliance control device 17 captures information of the multimedia of the digital camera 16 to obtain a plurality of related storage parameters. For example, the related storage parameters may be the photographing date (building date) of the captured file data (multimedia file data), the source position or the file size.

The digital-home-appliance control device 17 may collect the device information of the digital home appliance device 15 as a storage device with a high capacity to obtain the related storage parameter. The related storage parameter may be the available storage space, the usage condition of the storage device, the transmission bandwidth of the storage device, and the executing efficiency of the central processing unit of the storage device.

In addition, the digital-home-appliance control device 17 may obtain the related information (such as the brand of the manufacturer, the product model, the photographing pixel of the camera) of the digital camera which takes the photo as the related storage parameters.

In addition, the digital-home-appliance control device 17 may obtain the favorite setting of a user from a recording file or a history file. The favorite setting of a user is, for example, a prior storage position or a sequencing of the layer type, wherein the layer is implemented in a typical manner such as by device, disk driver or directory or is implement in the content aware manner such as by date or type (family, friend, travel or location).

Therefore, after the digital-home-appliance control device 17 collects the storage information in the above technical manner, the digital-home-appliance control device 17 determine the storage position of the multimedia of the digital camera 16 according to the collected information (step S115). That is, the digital-home-appliance control device 17 automatically choose the storage position according to the related storage parameters. For example, the digital-home-appliance control device 17 store the multimedia whose related storage parameter “source position” is “digital camera” to a predetermined position such as study computer/Drive E/My Favorite Media/.

Then, the digital-home-appliance control device 17 shows a prompt message from a digital television 11 electrically connected to the digital camera 16, so that a user choose to or not to accept the prompt message of predetermined storage directory (step S120). The predetermined storage directory may be, for example, family/Mar. 1˜15, 2006/Bali/Canon350D/8 MP. In other embodiment, the digital-home-appliance control device 17 also display the prompt message via other digital home appliance device with a screen.

In addition, in the embodiment, to make the recognition convenient, the digital-home-appliance control device 17 also select at least a characteristic graphic icon which is contracted from a picture to be the predetermined storage directory, and the contracted picture may be converted to a hash code to be read by any device and searched conveniently. In this way, the directory seen by the user is a contracted picture.

If the user accepts the automatic storage position and directory of the digital home appliance system 1, the user generate a confirming signal by a remote control device (such as a digital home appliance controller, a mobile phone, a PDA) or other input devices. Then the digital home appliance system 1 receives the confirming signal, it automatically stores the multimedia of the digital camera 16 to the proper position and generates a predetermined storage directory (such as the digital home appliance device 15). In other embodiment, if the user accepts the automatic storage directory of the digital home appliance system 1, after a predetermined time (such as five seconds), the digital-home-appliance control device 17 automatically stores the multimedia in the digital camera 16.

If the user does not accept the storage directory and position automatically generated by the digital home appliance system 1, the digital-home-appliance control device 17 displays a first parent predetermined directory (step S125) via the digital television 11, wherein the first parent predetermined directory is an upper layer of the predetermined directory. For example, if the predetermined directory is family/Mar. 1˜15, 2006/Bali/Canon350D/8 MP, the first parent predetermined directory is family/Mar. 1˜15, 2006/Bali/Canon350D. The user may choose to or not to accept the parent predetermined directory (step S130).

If the user still does not accept, the user control the digital television 11 to display a second parent directory via the control of a remote controller (such as via a mode of pressing direction keys), wherein the second parent directory is an upper layer of the first parent predetermined directory. Then, the user may choose a proper storage directory via the remote controller and even the proper storage position.

Generally speaking, after files are stored in a storage device, they are classified manually, and they cannot be stored automatically and cannot be automatically classified by indexing according to the photographing data of the file, the name of the photographic device, specific person or a group of persons and so on. In the embodiment, the digital-home-appliance control device 17 not only automatically store the files, but also classify the multimedia files according to the collected related storage information to execute a file classified management operation. For example, the digital-home-appliance control device 17 may automatically classify and store the files by indexing according to the photographing date, the name of the photographic device or specific person or a group of persons and so on.

FIG. 3 is a flowchart showing the method of avoiding the repeated storage of the directory in the automatic storage process according to the second preferred embodiment of the invention. Please also refer to FIG. 1. In the embodiment, the steps S305, S310, S325, S330, S335, and S340 are similar with the steps S105, S110, S115, S120, S125 and S130 in first embodiment, and only the step S315 and the step S320 are new added to avoid the repeated storage of the directory.

Since the data which is the same with the multimedia that the digital-home-appliance control device 17 wants to store may have been stored in the digital home appliance system, after the step S310 is executed in the embodiment, whether the same data has been existed in the digital home appliance system 1 is determined (step S315).

In the step S315, since the digital-home-appliance control device 17 has collected the related information in the step S310, the digital-home-appliance control device 17 may obtain the multimedia data which needs to be stored. In addition, the digital-home-appliance control device 17 analyze whether the digital home appliance system 1 has the same data, and the implement manner may be performed by keyword search technology. For example, when the digital-home-appliance control device 17 searches, it may search for the name of each folder. In other embodiment, the digital-home-appliance control device 17 also may search and compare each file in the digital home appliance system 1. In addition, in searching, the digital-home-appliance control device 17 also use a hash search manner with the directory as an object and according to the file size, file number and other related information to decrease the searching time.

After the digital-home-appliance control device 17 searches whether the same data exists, the digital-home-appliance control device 17 displays a data repeat prompt message to prompt the user whether to continue to store (step S320) via the digital television 11. If the user abandons saving the multimedia of the digital camera 16, the user may end the automatic storage process by the control of the remote controller. If the user still wants to store the multimedia of the digital camera 16, the user use the digital-home-appliance control device 17 to execute the step S325 by the control of the remote controller.

FIG. 4a and FIG. 4b are schematic diagrams of the third embodiment of the invention. Since in the digital home appliance system 1, the input device of the home appliance device cannot compare with the input device of the conditional computer, that is, the input device of the home appliance device is simpler, in the embodiment, a specific image or word picture may be selected by a frame selecting means to be a characteristic graphic icon. That is, a plurality of direction keys on the digital-home-appliance control device 17 are used to further execute the matrix frame selecting operation to replace the mouse to select the search criterion.

For example, please refer to FIG. 4a, and in the digital home appliance system 1, a home appliance device having a displaying function (such as the digital television 11) displays four linear cursors 111˜114 on the screen thereof, wherein the left direction key 171 of the digital-home-appliance control device 17 is used to control the right linear cursor 111 to move leftward, the right direction key 172 of the digital-home-appliance control device 17 is used to control the left linear cursor 112 to move rightward, the lower direction key 174 of the digital-home-appliance control device 17 is used to control the upper linear cursor 113 to move downward, and the upper direction key 173 of the digital-home-appliance control device 17 is used to control the lower liner cursor 114 to move upward. Then, when a user sets the search criterion, the user may make the linear cursors select a specific human facial characteristic or a specific word picture in the image file by pressing the direction keys, as shown in FIG. 4b.

Although the digital home appliance system 1 provided by the embodiment may store many multimedia files, the storage space of the digital home appliance system 1 is limited. Therefore, the invention further provides an automatic backup mechanism to solve the problem about backup.

FIG. 5 is an operation flowchart showing the automatic backup according to the fourth embodiment of the invention. Please refer to FIG. 1 and FIG. 5. In the embodiment, after the multimedia files are automatically stored in each database or storage device of the digital home appliance system 1, they are managed in a layer diary file structure manner. Since the layer diary file disclosed by the embodiment records the information about the file backup or revise, in the embodiment, a user may set the backup device (such as the digital-home-appliance control device 17, a host with a recorder or a disc driver designated by the user), and related information such as file capacity information or file revise information of each directory may be collected from a plurality of layer diary files. Then, the size of the multimedia file is added to an un-backup file size (step S505).

The backup device determines whether the un-backup file size exceeds a backup default file size (the backup default file size may be, for example, the size of the capacity of the recordable disc or the size of the capacity identified by the user) (step S510). If un-backup file size is larger than the backup default file size, the backup device displays a backup prompting message by the screen of the home appliance device (step S515). In addition, the backup device may establish a backup recognition string according to the collected related information.

Therefore, after the backup prompting message is displayed, the backup operation is executed (step SS520), which is predetermined to be executed manually or automatically. In the step S520, the backup device automatically searches new files to make a recording image file according to the collected related information, folders and the building or revising date of the files. In the single backup, the directory and the files which are bucked up by the backup device may come from different digital home appliance devices, different disk drivers (or storage devices) or is a single new added file which belongs to a directory which has been backed up.

From the above, the embodiment has disclosed many technical features which are different from the conventional technology. The digital home appliance system including a plurality of digital home appliance devices may automatically select the storage position according to data and the characteristics of the home appliances by collecting various related information and may classify and manage according to the nature of the multimedia files. The repeated storage of files may be avoided in the whole database (the digital home appliance system).

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An automatic file saving method for a digital home appliance system, the digital home appliance system comprising a plurality of digital home appliance devices with at least a storage position, the automatic file saving method comprising the steps of:
receiving a storage request for a file;
collecting the information of the file to obtain a related storage parameter; and
storing the file to the storage position corresponding to the related storage parameter.

2. The automatic file saving method according to claim 1, further comprising the step of displaying a prompt message to confirm whether to store the file to the storage position.

3. The automatic file saving method according to claim 1, further comprising the step of displaying a prompt message comprising a predetermined storage directory.

4. The automatic file saving method according to claim 1, wherein the predetermined storage directory is a contracted diagram of at least a picture in the file.

5. The automatic file saving method according to claim 1, further comprising the step of examining whether the plurality of the storage positions store the same file.

6. The automatic file saving method according to claim 5, wherein if the storage positions store the same file, the file is not stored.

7. The automatic file saving method according to claim 1, wherein the file is a multimedia file.

8. The automatic file saving method according to claim 1, wherein the related storage parameter comprises one of a building date, a file size, a source position, a file type and a characteristic graphic icon and any combination thereof.

9. The automatic file saving method according to claim 8, wherein the step of obtaining the characteristic graphic icon comprises the steps of:
providing a plurality of linear cursors at a screen of the digital home appliance system; and
defining the boundary of the characteristic graphic icon by the position of the linear cursors to select the characteristic graphic icon.

10. The automatic file saving method according to claim 9, wherein the initial positions of the linear cursors are the four sides of the screen.

11. The automatic file saving method according to claim 10, wherein the positions of the linear cursors are controlled by receiving control signals of a plurality of direction keys.

12. The automatic file saving method according to claim 9, wherein the characteristic graphic icon is used to be a predetermined graphic icon directory of the file.

13. The automatic file saving method according to claim 1, further comprising the steps of:
adding the size of the file to an un-backup file size;
comparing the un-backup file size with a backup default file size; and
displaying a backup prompting message if the un-backup file size exceeds the backup default file size.

14. The automatic file saving method according to claim 13, further comprising the step of executing a backup operation.

15. The automatic file saving method according to claim 14, wherein the backup operation is making a recording image file.

16. A digital home appliance system which is used to store a file automatically, the digital home appliance system comprising:
a plurality of digital home appliance devices with at least a storage position;
a digital-home-appliance control device used to receive a storage request for the file, collect information of the file to obtain a related storage parameter and store the file to the storage position corresponding to the related storage parameter; and
a domestic network linked to each of the digital home appliance devices and the digital-home-appliance control device to transmit data and control signals.

17. The digital home appliance system according to claim 16, wherein the domestic network comprises one of the IEEE 802.3 (high-speed Ethernet wireless network), the IEEE 802.11 (wireless network), the IEEE 802.15 (wireless personal area network), the Bluetooth network or the electric power wire network.

18. The digital home appliance system according to claim 16, wherein the digital home appliance devices comprise one of a refrigerator, a video device, an air conditioner, an oven, a storage device with a high capacity, a digital television, a computer, a digital camera and any combination thereof.

19. The digital home appliance system according to claim 18, wherein the storage device with a high capacity is selected from a redundant array of independent disks (RAID) or a network-attached storage (NAS).

20. The digital home appliance system according to claim 16, wherein the digital-home-appliance control device is one of a control host, a personal computer, a server or any combination thereof.
